(19) United States
(12) Patent Application Publication
(10) Pub. No.: US 2025/0130841 A1
(43) Pub. Date: Apr. 24, 2025

(54) LIFECYCLE MANAGEMENT OF HETEROGENEOUS CLUSTERS IN A VIRTUALIZED COMPUTING SYSTEM

(71) Applicant: VMware LLC, Palo Alto, CA (US)

(72) Inventors: ARJUN RAMAMURTHY, Bangalore (IN); ARAVINDA HARYADI, Bangalore (IN); MUKUND GUNTI, Sunnyvale, CA (US)

(21) Appl. No.: 18/607,191

(22) Filed: Mar. 15, 2024

(30) Foreign Application Priority Data
Oct. 19, 2023 (IN) 202341071431

(51) Int. Cl. G06F 9/455

(52) U.S. Cl. CPC G06F 9/45558; G06F 2009/45591

(57) ABSTRACT

An example method of hypervisor lifecycle management in a virtualized computing system having a cluster of hosts includes: obtaining, by a lifecycle manager (LCM) agent executing in a host of the hosts, a desired state document, the desired state document defining a desired state of software in the host, the software including a hypervisor; comparing selection criteria in the desired state document against hardware information obtained from a hardware platform of the host to select an image of a plurality of images defined in the desired state document; and applying, by LCM agent, the selected image to the host.

### CROSS-REFERENCE

This application is based upon and claims the benefit of priority from Indian Patent Application number 202341071431, filed on Oct. 19, 2023, the entire contents of which are incorporated herein by reference.

### BACKGROUND

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

A hypervisor lifecycle includes installing, patching, and upgrading the base operating system (OS) and/or other installed software, as well as managing the configuration of the hypervisor. It is desirable to perform these operations in a manner such that the VMs running on the hypervisor are not affected. A lifecycle manager executing in the datacenter can perform lifecycle management of homogeneous host clusters. In a homogeneous cluster, the lifecycle manager applies the same image to each host in the cluster. For example, each host in a homogenous cluster is from the same vendor and includes an identical hardware platform. Presently, a lifecycle manager does not support heterogeneous clusters. A heterogeneous cluster can have hosts from the same vendor but being of different generations/models requiring different add-ons and hardware support packages. A heterogenous cluster can have hosts from different vendors. A heterogenous cluster can have hosts that use different hypervisors versions. It is desirable to provide a lifecycle manager that supports heterogeneous clusters in a datacenter.

### SUMMARY

An example method of hypervisor lifecycle management in a virtualized computing system having a cluster of hosts is described. The method includes: obtaining, by a lifecycle manager (LCM) agent executing in a host of the hosts, a desired state document, the desired state document defining a desired state of software in the host, the software including a hypervisor; comparing selection criteria in the desired state document against hardware information obtained from a hardware platform of the host to select an image of a plurality of images defined in the desired state document; and applying, by LCM agent, the selected image to the host.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented,

FIG. 2 is a block diagram depicting a workflow for defining and applying desired state to a host cluster according to embodiments.

FIG. 3 is a block diagram depicting a set of images defined in a desired state document according to embodiments.

FIG. 4 is a flow diagram depicting a method of drafting a desired state document according to embodiments.

FIG. 5 is a flow diagram depicting a method of scanning the host cluster for lifecycle management according to embodiments.

FIG. 6 is a flow diagram depicting a method of updating a desired state document according to embodiments.

FIG. 7 is a flow diagram depicting a method of applying an image to a host according to embodiments.

### DETAILED DESCRIPTION

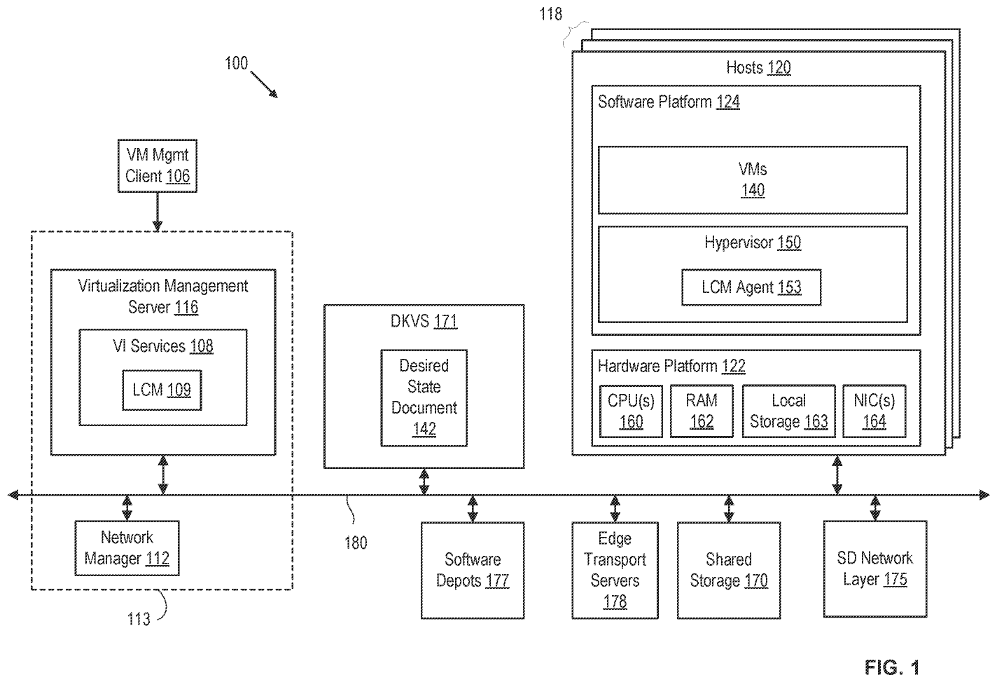

FIG. 1 is a block diagram of a virtualized computing system 100 in which embodiments described herein may be implemented. System 100 includes a cluster of hosts 120 (“host cluster 118”) that may be constructed on hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein.

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks (SSDs), flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170. Virtualization management server 116 can select which local storage devices in hosts 120 are part of a virtual SAN for host cluster 118.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

In embodiments, host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc.). Edge transport servers 178 can include a gateway between the internal logical networking of host cluster 118 and the external network. Edge transport servers 178 can be physical servers or VMs.

Virtualization management server 116 is a physical or virtual server that manages host cluster 118 and the virtualization layer therein. Virtualization management server 116 installs agent(s) in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. In this manner, host cluster 118 can be a cluster 103 of transport nodes. One example of an SD networking platform that can be configured and used in embodiments described herein as network manager 112 and SD network layer 175 is a VMware NSX® platform made commercially available by VMware, Inc. of Palo Alto, CA.

Virtualization management server 116 and network manager 112 comprise a virtual infrastructure (VI) control plane 113 of virtualized computing system 100. In embodiments, network manager 112 is omitted and virtualization management server 116 handles virtual networking. Virtualization management server 116 can include VI services 108. VI services 108 include various virtualization management services, such as a distributed resource scheduler (DRS), high-availability (HA) service, single sign-on (SSO) service, virtualization management daemon, vSAN service, and the like. DRS is configured to aggregate the resources of host cluster 118 to provide resource pools and enforce resource allocation policies. DRS also provides resource management in the form of load balancing, power management, VM placement, and the like. HA service is configured to pool VMs and hosts into a monitored cluster and, in the event of a failure, restart VMs on alternate hosts in the cluster. A single host is elected as a master, which communicates with the HA service and monitors the state of protected VMs on subordinate hosts. The HA service uses admission control to ensure enough resources are reserved in the cluster for VM recovery when a host fails. SSO service comprises security token service, administration server, directory service, identity management service, and the like configured to implement an SSO platform for authenticating users. The virtualization management daemon is configured to manage objects, such as data centers, clusters, hosts, VMs, resource pools, datastores, and the like.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, and the like.

In embodiments, VI services 108 includes a lifecycle manager (LCM) 109. LCM 109 cooperates with agents installed in hypervisors 150 (LCM agents 153). LCM agent 153 performs lifecycle operations on hypervisor 150. Lifecycle operations include patching and upgrading the base operating system, patching and upgrading installed software, managing the configuration of hypervisor 150, and the like. LCM agent 153 performs lifecycle operations based on a desired state document. The desired state document defines a desired state for cluster 118. LCM 109 is configured to define and manage the desired state document for cluster 118. In embodiments, the desired state document supports a heterogenous cluster. In a heterogeneous cluster, hosts 120 require more than one image, e.g., hosts 120 can be from different vendors, be from the same vendor but be of different generations/models, have different hypervisor versions, and the like. In such a heterogenous cluster, a single image cannot be applied across all hosts since different hosts require different add-ons, hardware support packages, and the like. Software for images can be stored in software depot(s) 177.

Virtualized computing system 100 includes a distributed key-value store (DKVS) 171. In embodiments, DKVS 171 comprises software executing in a plurality of VMs 140. For purposes of clarity. DKVS 171 is shown as a separate logical component in FIG. 1. DKVS 171 provides high availability, redundancy, and fault tolerance that allows the lifecycle operations to scale with the number of hosts 120 in host cluster 118. Users create a desired state document 142, which is stored in DKVS 171. For example, users can interact with virtualization management server 116 using VM management client 106 to define or provide a state document 142. Virtualization management server 116 can store desired state document 142 in DKVS 171. Desired state document 142 defines software and configuration for hypervisors 150 in hosts in a declarative, human-readable form.

According to embodiments, software installation bundles (SIBs), more generally referred to herein as payloads, are logically grouped into “components.” In the embodiments, a component is a unit of shipment and installation, and a successful installation of a component typically will appear to the end user as enabling some specific feature of hypervisor 150. For example, if a software vendor wants to ship a user-visible feature that requires a plug-in, a driver, and a solution, the software vendor will create separate payloads for each of the plug-in, the driver, and the solution, and then group them together as one component. From the end user's perspective, it is sufficient to install this one component onto a server to enable this feature on the server. A component may be part of another software image, such as a base image or an add-on, as further described below, or it may be a stand-alone component provided by a third-party or the end user (hereinafter referred to as “user component”).

A “base image” is a collection of components that are sufficient to boot up a server with the virtualization software. For example, the components for the base image include a core kernel component and components for basic drivers and in-box drivers. The core kernel component is made up of a kernel payload and other payloads that have inter-dependencies with the kernel payload. According to embodiments, the collection of components that make up the base image is packaged and released as one unit.

An “add-on” or “add-on image” is a collection of components that the OEM wants to bring together to customize its servers. Using add-ons, the OEM can add, update or remove components that are present in the base image. The add-on is layered on top of the base image and the combination includes all the drivers and solutions that are necessary to customize, boot up and monitor the OEM's servers. Although an “add-on” is always layered on top of a base image, the add-on content and the base image content are not tied together. As a result, an OEM is able to independently manage the lifecycle of its releases. In addition, end users can update the add-on content and the base image content independently of each other.

“Solutions” are features that indirectly impact the desired image when they are enabled by the end user. In other words, the end-user decides to enable the solution in a user interface but does not decide what components to install. The solution's management layer decides the right set of components based on constraints. Examples solutions include HA (high availability), and NSX (network virtualization platform of VMware, Inc.).

One example form for expressing the desired state is desired state document 142. A desired state document can define a default image and one or more alternative images. Each image can define: (1) base image, (2) add-on, (3) solution, (4) user component(s), and (5) firmware package, and the like for hypervisor 150 and its host 120. Different alternative images can support different hosts in the heterogenous cluster (e.g., different hardware platforms). As discussed further below, LCM agent 153 can obtain or be notified of desired state document 142 and perform lifecycle operations in case the current state of host 120 differs from the desired state specified in desired state document 142. LCM agent 153 applies a selected image based on selection criteria, as discussed further below,

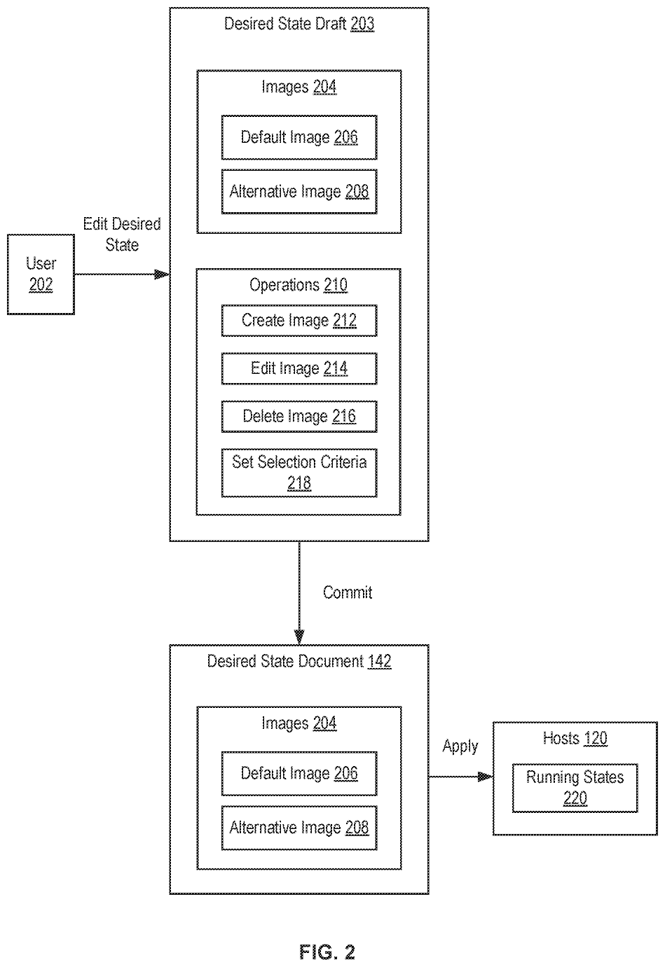

FIG. 2 is a block diagram depicting a workflow for defining and applying desired state to a host cluster according to embodiments. A user 202 interacts with LCM 109 to edit desired state and define a desired state draft 203. Desired state draft 203 includes images 204. User 202 interacts with LCM 109 to perform operations 210, which include creating an image 212, editing an image 214, deleting an image 216, and setting selection criteria 218. Images 204 include a default image 206 and one or more alternative images 208. Default image 206 does not include any selection criteria. Each alternative image 208 includes selection criteria 218 associated therewith. User 202 interacts with LCM 109 to commit desired state draft 203. LCM 109 generates or updates desired state document 142 to be consistent with desired state draft 203. Desired state document 142 includes definitions for images 204, including default image 206 and one or more alternative images 208. LCM agents 153 executing in hosts 120 then apply desired state document 142 to update running states 220 of hypervisors 150.

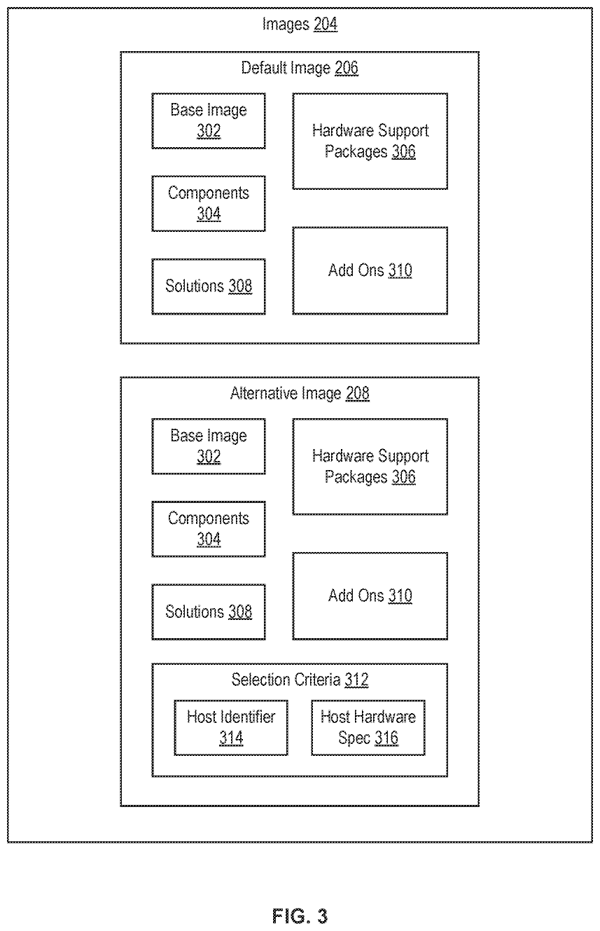

FIG. 3 is a block diagram depicting a set of images defined in a desired state document according to embodiments. Images 204 include default image 206 and an alternative image 208 (e.g., only one alternative image is shown but images 204 can include more than one alternative image). Default image 206 is defined to include a base image 302. Default image 206 can include other defined parts, including component(s) 304, solutions 308, hardware support packets 306, and add-ons 310. Component(s) 304 can be any component that is not part of base image 302 (e.g., tools software). Hardware support packages 306 can include drivers and the like software that provide support for a hardware platform 122. Base image 302, solutions 308, and add-ons 310 are discussed above.

Alternative image 208 is defined similar to default image 206. Alternative image includes base image 302, components 304, solutions 308, hardware support packages 306, and add-ons 310. Some parts of alternative image can be different from default image 206. For example, alternative image 208 can be defined for a specific type of host 120 (e.g., host from a specific vendor having a specific generation/model). Thus, hardware support packages 306 and add-ons 310 can be defined specific to that type of host. Base image 302, components 304, and solutions 308 can be common between default image 206 and alternative image 208 (although this is not required). Selection criteria 312 is defined to determine if alternative image 208 should be applied to a specific host 120. In embodiments, selection criteria 312 includes a host identifier 314. If a host 120 has that host identifier 314, then alternative image 208 is applied to that host. In embodiments, selection criteria 312 includes host hardware specification 316. If a host 120 has a hardware platform 122 that matches host hardware specification 316, then alternative image 208 is applied to that host.

A sample desired state document is defined below. First, a default image can be defined as follows:

```
{
// DEFAULT image
“add_on”: null,
“base_image”: {
“version”: “7.0.3-0.40.19898904”
},
“components”: {
  “VMware-VM-Tools”: “12.1.0.20219665-20295239”
},
“hardware_support”: null,
“solutions”: {
  “com.vmware.vsphere-ha”: {
    “components”: [
      {
        “component”: “vsphere-fdm”
      }
  ],
  “version”: “8.0.0-20078399”
  }
}, ....
```

In the example, the default image includes a base image and an additional component of VMware-VM-Tools. The default image includes a solution identified as “vsphere-HA” (e.g., high availability solution). The default image does not include any add-ons or hardware support packages.

An alternative image can be defined as follows:

```
“alternative_images”: {
“04b7c69c-c0f2-47ca-a078-b5e598656a6a”: {
“add_on”: {
  “name”: “OEM-1-Addon”,
  “version”: “1.0.0-123”
},
“base_image”: {
  “version”: “7.0.3-0.40.19898904”
},
“components”: {
  “VMware-VM-Tools”: “12.1.0.20219665-20295239”
},
“hardware_support”: {
  “name”: “OEM-1-HSP”,
  “version”: “2.0.0-123”
},
“solutions”: {
  “com.vmware.vsphere-ha”: {
    “components”: [
    {
      “component”: “vsphere-fdm”
    }
  ],
  “version”: “8.0.0-20078399”
}
},
// This could be used by the UI as a title for Image card
“display_name”: “OEM 1 for Gen9”,
“selection_criteria”: {
  // SELECTION_TYPE can be HOST_UUID OR
  HOST_HARDWARE_SPEC
  “selection_type”: “<SELECTION_TYPE>”,
// SELECTION_TYPE-HOST_UUID, uuid will be used
  “host_uuid”: [“host-01-system-uuid”, “host-02-system-uuid”],
// SELECTION_TYPE=HOST_HARDWARE_SPEC, vendor, model,
oem_string will be used
// Selection logic can be
// AND operation across the attributes and OR operation within an attribute
// Ex: “OEM-1” AND (“Model Gen9” OR “Model Gen10”) AND
// (“OEM String 1” OR “OEM String 2”)
  “host_hardware_spec”: {
  // Maps to “Manufacturer” in SMBIOS: System Information (Type 1)
    “vendor”: “OEM-1”,
  // Maps to “Product Name” in SMBIOS: System Information (Type 1)
    “model”: [“Model Gen9”, “Model Gen10”],
  // Maps to “Family” in SMBIOS: System Information (Type 1)
    “family”: [“Family-1”, “Family-2”],
  // Maps to SMBIOS: OEM Strings (Type 11)
    “oem_string”: [“OEM String 1”, “OEM String 2”]
}
}
}, ...
```

In the above example, the alternative image includes an add-one (e.g., “OEM-1-Addon”), a base image, an additional component (e.g., VMware-VM-Tools), a hardware support package (e.g., “OEM-1-HSP”), a solution (e.g., vsphere-HA). The alternative image includes selection criteria. The parameter “selection type” can be set to selection which type of selection criteria is valid. A selection type of HOST_UUID indicates the host identifier is used. A selection type HOST_HARDWARE_SPEC indicates the host hardware specification is used. Note logical operations (e.g., logical and, logical or, etc.) can be used for either host identifier or host hardware specification (e.g., multiple host identifiers or'd together). In case of host hardware specification, the types of parameters can include, for example, vendor indicator, model indicator, family indicator, OEM string indicator, or the like. These values can be obtained from the host hardware platform (e.g., firmware).

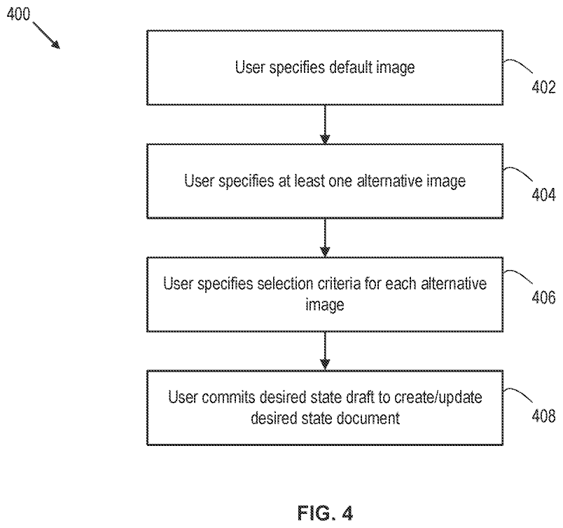

FIG. 4 is a flow diagram depicting a method 400 of drafting a desired state document according to embodiments. Method 400 begins at step 402, where a user interacts with LCM 109 to specify a default image. The default image can be specified as described above, e.g., base image, solutions, add-ons, components, hardware support packages, etc. At step 404, the user specifies at least one alternative image. An alternative image can be specified as described above, e.g., e.g., base image, solutions, add-ons, components, hardware support packages, etc. At step 406, the user specifies selection criteria for each alternative image. The selection criteria can be specified as described above (e.g., host identifier, hardware specification, etc.). At step 408, the user commits the desired state draft and LCM 109 creates/updates desired state document 142 to be consistent with the draft.

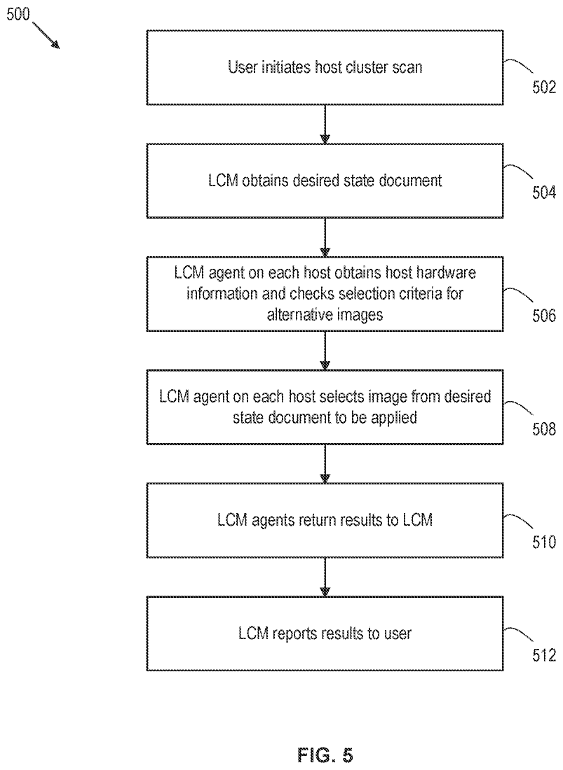

FIG. 5 is a flow diagram depicting a method 500 of scanning the host cluster for lifecycle management according to embodiments. Method 500 begins at step 502, where the user initiates a host cluster scan. At step 504, LCM 109 obtains desired state document 142. LCM 109 can determine the possible images from desired state document. At step 506, LCM 109 cooperates with LCM agents 153 to obtain host hardware information and check selection criteria in desired state document for alternative image(s). At step 508, each LCM agent 153 selects an image from the desired state document applicable to its host. LCM agent 153 selects an alternative image that has selection criteria that matches hardware information of the host. If no alternative image is applicable, LCM agent 153 selects the default image. If multiple alternative images are applicable, LCM agent 153 indicates each alternative image that is applicable. At step 510, each LCM agent 153 returns its scan results to LCM 109. At step 512, LCM 109 reports the scan results to the user. The user can view the results and remediate the host cluster as necessary (e.g., in case default image is being applied by mistake, in case there are multiple applicable alternative images, etc.).

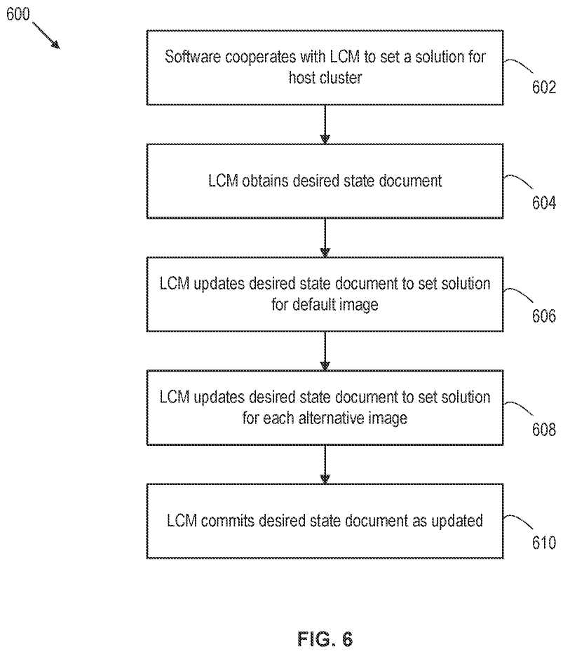

FIG. 6 is a flow diagram depicting a method 600 of updating a desired state document according to embodiments. Method 600 begins at step 602, where software cooperates with LCM 109 to set a solution for a host cluster. For example, network manager 112 can cooperate with LCM 109 to set a network management solution. At step 604, LCM 109 obtains desired state document 142. At step 606, LCM 109 updates desired state document 142 to set the solution for the default image. At step 608, LCM 109 updates desired state document 142 to set the solution for each alternative image. At step 610, LCM 109 commits the desired state document 142. In this manner, LCM 109 accounts for the multiple images defined in desired state document 142 and network manager 112 is agnostic to the presence or absence of such multiple images.

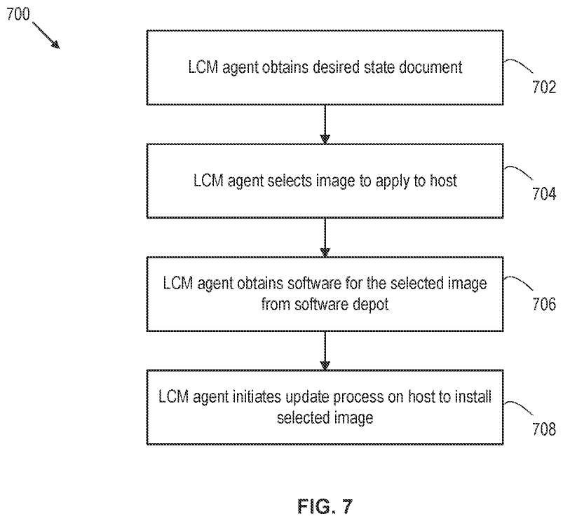

FIG. 7 is a flow diagram depicting a method 700 of applying an image to a host according to embodiments. At step 702, LCM agent 153 obtains desired state document 142. At step 704, LCM agent 153 selects an image to apply (e.g., as described above in method 500). At step 706, LCM agent 153 obtains software from a depot that is defined in the selected image. At step 708, LCM agent 153 initiates an update process on the host to install the selected image.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of hypervisor lifecycle management in a virtualized computing system having a cluster of hosts, the method comprising:
obtaining, by a lifecycle manager (LCM) agent executing in a host of the hosts, a desired state document, the desired state document defining a desired state of software in the host, the software including a hypervisor;
comparing selection criteria in the desired state document against hardware information obtained from a hardware platform of the host to select an image of a plurality of images defined in the desired state document; and
applying, by LCM agent, the selected image to the host.

2. The method of claim 1, wherein the desired state document defines a default image and an alternative image, the alternative image associated with the selection criteria.

3. The method of claim 2, wherein the default image is not associated with any selection criteria.

4. The method of claim 2, further comprising:
determining, by the LCM agent, that the hardware information matches the selection criteria;
wherein the selected image comprises the alternative image.

5. The method of claim 2, further comprising:
determining, by the LCM agent, that the hardware information does not match the selection criteria;
wherein the selected image comprises the default image.

6. The method of claim 1, further comprising:
receiving, at an LCM from a user, a draft of the desired state document; and
committing, by the LCM, the draft to generate the desired state document.

7. The method of claim 1, wherein the selection criteria includes a host identifier or a hardware specification.

8. A non-transitory computer readable medium comprising instructions to be executed in a computing device to cause the computing device to carry out a method of hypervisor lifecycle management in a virtualized computing system having a cluster of hosts, the method comprising:
obtaining, by a lifecycle manager (LCM) agent executing in a host of the hosts, a desired state document, the desired state document defining a desired state of software in the host, the software including a hypervisor;
comparing selection criteria in the desired state document against hardware information obtained from a hardware platform of the host to select an image of a plurality of images defined in the desired state document; and
applying, by LCM agent, the selected image to the host.

9. The non-transitory computer readable medium of claim 8, wherein the desired state document defines a default image and an alternative image, the alternative image associated with the selection criteria.

10. The non-transitory computer readable medium of claim 9, wherein the default image is not associated with any selection criteria.

11. The non-transitory computer readable medium of claim 9, further comprising:
determining, by the LCM agent, that the hardware information matches the selection criteria;
wherein the selected image comprises the alternative image.

12. The non-transitory computer readable medium of claim 11, further comprising:
determining, by the LCM agent, that the hardware information does not match the selection criteria;
wherein the selected image comprises the default image.

13. The non-transitory computer readable medium of claim 8, further comprising:
receiving, at an LCM from a user, a draft of the desired state document; and
committing, by the LCM, the draft to generate the desired state document.

14. The non-transitory computer readable medium of claim 8, wherein the selection criteria includes a host identifier or a hardware specification.

15. A virtualized computing system having a cluster comprising hosts connected to a network, the virtualized computing system comprising:
a distributed key-value store configured to store a desired state document; and
a first host of the hosts configured to execute a lifecycle manager (LCM) agent, the LCM agent configured to:
obtain the desired state document, the desired state document defining a desired state of software in the host, the software including a hypervisor;
compare selection criteria in the desired state document against hardware information obtained from a hardware platform of the host to select an image of a plurality of images defined in the desired state document; and
apply the selected image to the host.

16. The virtualized computing system of claim 15, wherein the desired state document defines a default image and an alternative image, the alternative image associated with the selection criteria.

17. The virtualized computing system of claim 16, wherein the default image is not associated with any selection criteria.

18. The virtualized computing system of claim 16, wherein the LCM agent is configured to:
determine that the hardware information matches the selection criteria;
wherein the selected image comprises the alternative image.

19. The virtualized computing system of claim 16, wherein the LCM agent is configured to:
determine that the hardware information does not match the selection criteria;
wherein the selected image comprises the default image.

20. The virtualized computing system of claim 15, wherein the selection criteria includes a host identifier or a hardware specification.
